(19) United States
(12) Patent Application Publication
(10) Pub. No.: US 2004/0012565 A1
(43) Pub. Date: Jan. 22, 2004

(54) Interactive display

(75) Inventor: Ronald S. Cok, Rochester, NY (US)

Correspondence Address: Thomas H. Close, Patent Legal Staff, Eastman Kodak Company, 343 State Street, Rochester, NY, 14650-2396, US

(73) Assignee: Eastman Kodak Company

(21) Appl. No.: 10/201,237

(22) Filed: Jul. 22, 2002

(51) Int. Cl. G09G 5/08

(52) U.S. Cl. 345/158

(57) ABSTRACT

An OLED display includes: a two dimensional array of light emitting pixels for displaying an image; a two dimensional array of photosensors interspersed with the array of light emitting pixels for producing an incident light signal; and a display controller connected to the array of photosensors, the display controller including a signal processor responsive to the incident light signal for detecting the location of a point of light directed onto the display by a light emitting pointer and generating a pointer signal representing the location of the point of light.

### FIELD OF THE INVENTION

The present invention relates to flat-panel OLED displays and, more particularly, to a means for interacting with the OLED display.

### BACKGROUND OF THE INVENTION

Electronic display systems are commonly used to display information from computers. Typical display systems range in size from small displays used in mobile devices to very large displays visible to thousands of viewers. Large displays are sometimes created by tiling smaller display devices together. For example, video walls using multiple video displays are frequently seen in the electronic media and flat-panel displays are tiled to create larger displays. Multiple projector systems used to create a large, tiled, high-resolution display are also available.

Tiled arrays of display devices are well known in the art. For example, Rainbow Systems, Inc. markets large-size flat-panel displays composed of two or three smaller LCD displays. The Rainbow Spectrum Model 3750 consists of three separate panels. Tiled OLED arrays can be integrated using available active-matrix displays by joining them into large two-dimensional arrays. For example, WO 99/41732 by Matthies et al., published Aug. 19, 1999, describes forming a tiled display device from display tiles having pixel positions defined up to the edge of the tiles.

It is also known to create tiled displays using conventional display elements and an optical face plate that hides the seams between tiles. U.S. Pat. No. 6,014,232 issued Jan. 11, 2000 to Clarke, describes a plurality of panels with lens-lets associated with pixel(s) to create a diverging image enabling tiling of panels in an image sensor or display device U.S. Pat. Nos. 5,465,315 issued Nov. 7, 1995, and 5,502,457 issued Mar. 26, 1996 to Sakai et al., describe an array of bent fibers placed above each tile of a multi-tile display system.

Many display systems, especially those used in mobile devices, have means to interact with users. The interaction is usually accomplished with a pressure-sensitive resistive-wire device placed above the display device. These touch screens incorporate an active area surrounded by patterned conductors connected to a cable Other technologies, such as acoustic wave, infrared, or capacitive sensors likewise require a border surrounding the display area. Very large touch screens are difficult and expensive to manufacture. U.S. Pat. No. 6,118,433, issued Sep. 12, 2000 to Jenkin et al. describes a large-scale, touch-sensitive video display using flat-panel devices and tiles of conventional touch screens. This approach to providing an interactive display has the disadvantages that the display is not seamless and is not useful if the display is out of reach of a user, thereby preventing a physical touch of the display screen.

An alternate mechanism for interaction with displays is found for example in arcade games. An interactive pointer, such as a fake gun, includes a photosensor that is directed at a CRT display. The timing of the detected signal in conjunction with the timing signals for the display device, is employed to determine the direction that the gun was aimed when the trigger was pulled. This technique may not produce an unambiguous result if the display is tiled, since multiple portions of the display will be emitting light simultaneously.

Laser pointers are well known for use in presentations, but they do not interact with the display.

There is a need therefore for an improved interactive display that avoids the problems described above.

### SUMMARY OF THE INVENTION

The need is met according to the present invention by providing an OLED display having a two dimensional array of light emitting pixels for displaying an image; a two dimensional array of photosensors interspersed with the array of light emitting pixels for producing an incident light signal; and a display controller connected to the array of photosensors, the display controller including a signal processor responsive to the incident light signal for detecting the location of a point of light directed onto the display by a light emitting pointer and generating a pointer signal representing the location of the point of light.

### ADVANTAGES

The present invention has the advantage of providing a display that can be controlled with a laser pointer and the display can be seamlessly tiled.

### BRIEF DESCRIPTION OF THE DRAWINGS

FIG. 1 is a schematic diagram illustrating an interactive tiled display according to the present invention;

FIG. 2 is a schematic diagram of a display tile according to the present invention;

FIG. 3 is a schematic diagram of the display controller used in the present invention;

FIG. 4 is a flow chart showing the signal processing steps implemented by the signal processor in the display controller;

FIG. 5 is a schematic side view of a tiled display having image expanding fiber optic faceplates; and

FIG. 6 is a schematic diagram illustrating preferred construction of the light emitting OLED pixels as is known in the prior art.

### DETAILED DESCRIPTION OF THE INVENTION

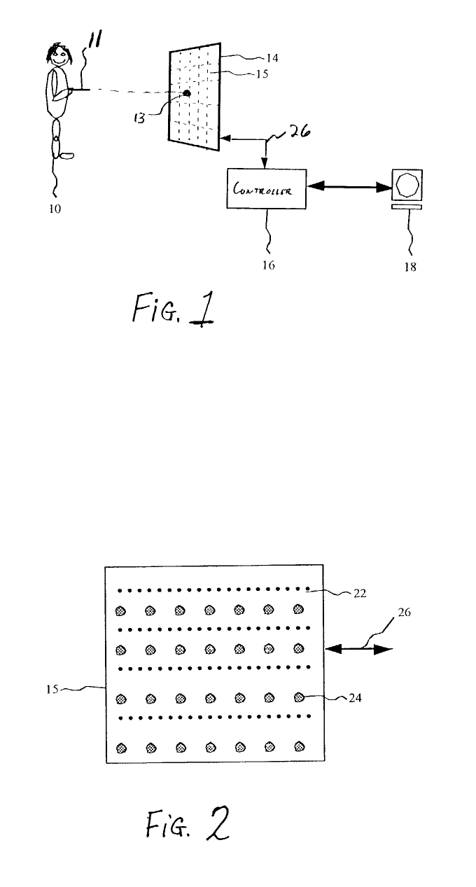

Referring to FIG. 1, a tiled interactive display 14 includes a plurality of OLED display tiles 15 connected to a controller 16. The OLED display tiles include a two dimensional array of light emitting pixels for displaying an image and a two dimensional array of photosensors interspersed with the array of light emitting pixels for producing an incident light signal. A user 10 holding a light emitting pointer 11 such as a laser pointer, shines a point of light 13 on to the tiled interactive display 14. Laser pointers are commercially available, low-cost devices used in public presentations. They typically emit red light but laser pointers with other frequencies are known. A two-dimensional array of photosensors is included in each tile of the display. A display controller 16 connected to the arrays of photosensors includes a signal processor responsive to the incident light signal for detecting the location of the point of light directed onto the display by the light emitting pointer and generating a pointer signal representing the location of the point of light. The controller 16 is connected to a computer 18, such as a personal computer. The personal computer is programmed to respond to the pointer signal to selectively change the image being displayed in response to the location of the point of light produced by the light emitting pointer.

Any of the techniques known in the art for creating a tiled display with display tiles may be used with the present invention. Referring to FIG. 2, a display tile 15 includes a two dimensional array of light emitting pixels 22 interspersed with a two dimensional array of photosensors 24. The light emitting pixels 22 are energized and the incident light signal from the photosensors 24 are communicated via a standard communication interface 26 using transistors and integrated circuit design techniques well known in the art. FIG. 2 is not drawn to scale so as to facilitate clarity in illustration. The photosensors 24 can be made from any photo-active material compatible with the manufacturing process of the OLED display tile, for example, silicon photo-diodes. U.S. Pat. No. 5,929,845, issued Jul. 27, 1999 to Wei et al., references the use of a common technology for OLEDs to serve as both illuminators and sensors alternately. The resolution of the light emitting portion of the display may be different from that of the photosensor portion. For example, a photosensor may be associated with each light emitting pixel or with groups of light emitting pixels. In practice, the number of photosensors will determine the spatial specificity of the pointing operation. Moreover, the light from the pointer may spread somewhat and be detected by more than one photosensor which will also affect the spatial specificity of the pointing operation.

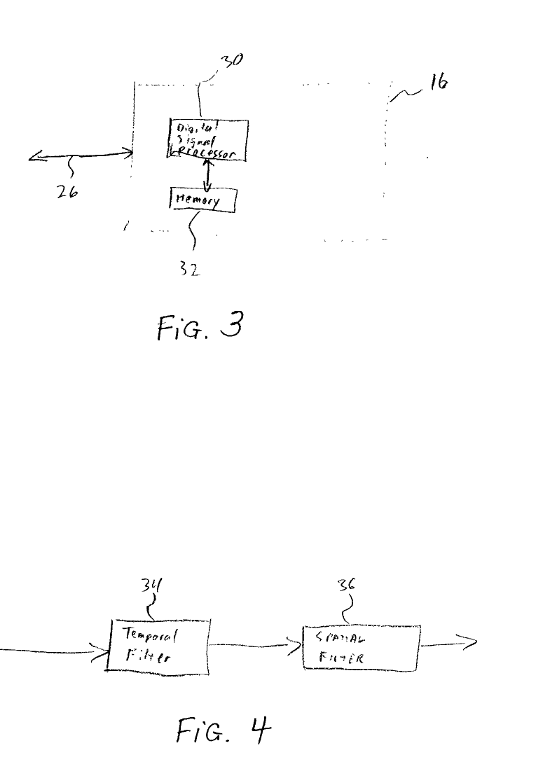

Referring to FIG. 3, the controller 16 includes digital signal processor 30 and memory 32 for temporarily storing and processing the incident light signals from the photosensors to detect the location of the point of light. Such processing is well known in the conventional art and can include, for example, thresholding operations, convolutions, morphological operations, and the like. Referring to FIG. 4, according to a preferred embodiment of the present invention, the digital signal processor implements a temporal filter 34 that produces a difference signal from successive incident light signals, and a spatial filter 36 responsive to the difference signal to generate a pointer signal indicating the location of the point of light. The temporal filtering~operation removes the effects of unchanging ambient light and light from the light emitting pixels of the display, and the spatial filter detects a spot like change in the ambient illumination falling on the interactive display, thereby distinguishing light from the pointer from other changes in ambient light reaching the surface of the interactive display. Once the location of the point of light has been determined with respect to the image pixels, the information is passed to the application software in computer 18 controlling the display and user interactions. In a preferred embodiment, the image on the display is a graphic user interface as is well known in the art. The present invention can provide traditional interaction capabilities such as highlighting elements in an image, selecting from menu lists or drag-and-drop operations in a graphical interfaces.

In an alternative embodiment, the light from the pointer is modulated in time to communicate further information to the display controller 16. The controller 16 is programmed to extract the modulation frequency from the pointer signal using time domain processing and communicates the modulation frequency to the application program running on computer 18. In this way, the equivalent of mouse button controls can be provided on the laser pointing device by providing a switch that can be activated by the user to change the temporal modulation frequency of the light beam. The modulation can be employed to communicate digital information to the controller, or different frequencies of modulation can be employed to distinguish between a plurality of pointing devices employed by different users such that the input from multiple users can be simultaneously supported and their independent interaction identified. Such a feature is useful for example in a game that supports simultaneous input from a plurality of players.

Referring to FIG. 5, the present invention employs tiled arrays of OLED display devices 15 that include image expanding optical faceplates 17 used to reduce the visibility of seams in the display. Such image expanding faceplates 17 typically conduct light from the display tile 15 to a viewable surface 19 and may incorporate a light pipe 21 associated with each light emitting pixel 22 and each photosensor 24 or incorporate multiple light pipes per pixel or photosensor. The image expanding optical faceplates conduct light to the display tile so that light from a pointer is conducted from the viewable surface 19 to the photosensors 24.

In a preferred embodiment, the OLED light emitting pixels are composed of small molecule or polymeric OLEDs as disclosed in but not limited to U.S. Pat. No. 4,769,292, issued Sep. 6, 1988 to Tang et al. and U.S. Pat. No. 5,061,569, issued Oct. 29, 1991 to VanSlyke et al. Many combinations and variations of organic light emitting displays can be used to fabricate such a device. The preferred pointing device is a low-intensity red laser pointer.

Details of the OLED materials, layers, and architecture are described in more detail below.

General Device Architecture

The present invention can be employed in most OLED device configurations. These include very simple structures comprising a single anode and cathode to more complex devices, such as passive matrix displays comprised of orthogonal arrays of anodes and cathodes to form pixels, and active-matrix displays where each pixel is controlled independently, for example, with thin-film transistors (TFTs).

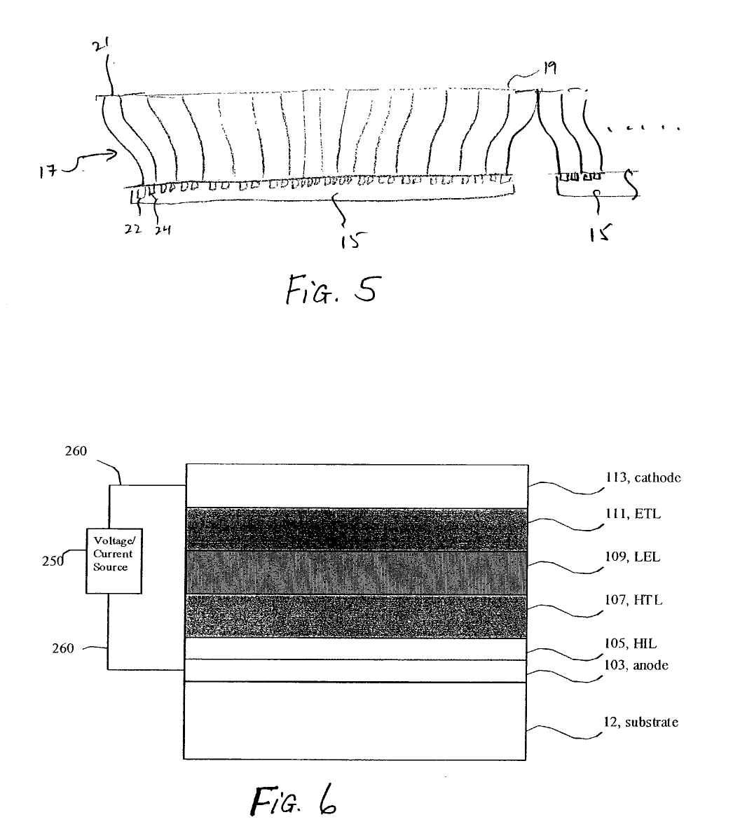

There are numerous configurations of the organic layers wherein the present invention can be successfully practiced. A typical structure is shown in FIG. 6 and is comprised of a substrate 12, an anode 103, a hole-injecting layer 105, a hole-transporting layer 107, a light-emitting layer 109, an electron-transporting layer 111, and a cathode 113. These layers are described in detail below. Note that the substrate may alternatively be located adjacent to the cathode, or the substrate may actually constitute the anode or cathode. The organic layers between the anode and cathode are conveniently referred to as the organic EL element. The total combined thickness of the organic layers is preferably less than 500 nm.

The anode and cathode of the OLED are connected to a voltage/current source 250 through electrical conductors 260. The OLED is operated by applying a potential between the anode and cathode such that the anode is at a more positive potential than the cathode. Holes are injected into the organic EL element from the anode and electrons are injected into the organic EL element at the anode. Enhanced device stability can sometimes be achieved when the OLED is operated in an AC mode where, for some time period in the cycle, the potential bias is reversed and no current flows. An example of an AC driven OLED is described in U.S. Pat. No. 5,552,678.

Substrate

The OLED device of this invention is typically provided over a supporting substrate where either the cathode or anode can be in contact with the substrate. The electrode in contact with the substrate is conveniently referred to as the bottom electrode. Conventionally, the bottom electrode is the anode, but this invention is not limited to that configuration. The substrate can either be light transmissive or opaque, depending on the intended direction of light emission. The light transmissive property is desirable for viewing the EL emission through the substrate. Transparent glass or plastic is commonly employed in such cases. For applications where the EL emission is viewed through the top electrode, the transmissive characteristic of the bottom support is immaterial, and therefore can be light transmissive, light absorbing or light reflective. Substrates for use in this case include, but are not limited to, glass, plastic, semiconductor materials, silicon, ceramics, and circuit board materials. Of course it is necessary to provide in these device configurations a light-transparent top electrode.

Anode

When EL emission is viewed through anode 103, the anode should be transparent or substantially transparent to the emission of interest. Common transparent anode materials used in this invention are indium-tin oxide (ITO), indium-zinc oxide (IZO) and tin oxide, but other metal oxides can work including, but not limited to, aluminum- or indium-doped zinc oxide, magnesium-indium oxide, and nickel-tungsten oxide. In addition to these oxides, metal nitrides, such as gallium nitride, and metal selenides, such as zinc selenide, and metal sulfides, such as zinc sulfide, can be used as the anode. For applications where EL emission is viewed only through the cathode electrode, the transmissive characteristics of anode are immaterial and any conductive material can be used, transparent, opaque or reflective. Example conductors for this application include, but are not limited to, gold, iridium, molybdenum, palladium, and platinum. Typical anode materials, transmissive or otherwise, have a work function of 4.1 eV or greater. Desired anode materials are commonly deposited by any suitable means such as evaporation, sputtering, chemical vapor deposition, or electrochemical means Anodes can be patterned using well-known photolithographic processes. Optionally, anodes may be polished prior to application of other layers to reduce surface roughness so as to minimize shorts or enhance reflectivity.

Hole-Injecting Layer (HIL)

While not always necessary, it is often useful to provide a hole-injecting layer 105 between anode 103 and hole-transporting layer 107. The hole-injecting material can serve to improve the film formation property of subsequent organic layers and to facilitate injection of holes into the hole-transporting layer. Suitable materials for use in the hole-injecting layer include, but are not limited to, porphyrinic compounds as described in U.S. Pat. No. 4,720,432, plasma-deposited fluorocarbon polymers as described in U.S. Pat. No. 6,208,075, and some aromatic amines, for example, m-MTDATA (4,4′,4″-tris[(3-methylphenyl)phenylamino]triphenylamine). Alternative hole-injecting materials reportedly useful in organic EL devices are described in EP 0 891 121 A1 and EP 1 029 909 A1.

Hole-Transporting Layer (HTL)

The hole-transporting layer 107 contains at least one hole-transporting compound such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. in U.S. Pat. No. 3,180,730. Other suitable triarylamines substituted with one or more vinyl radicals and/or comprising at least one active hydrogen containing group are disclosed by Brantley et al U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. The hole-transporting layer can be formed of a single or a mixture of aromatic tertiary amine compounds. Illustrative of useful aromatic tertiary amines are the following:

1,1 -Bis(4-di-p-tolylaminophenyl)cyclohexane

1,1 -Bis(4-di-p-tolylaminophenyl)-4-phenylcyclohexane

4,4′-Bis(diphenylamino)quadriphenyl

Bis(4-dimethylamino-2-methylphenyl)-phenylmethane

N,N,N-Tri(p-tolyl)amine

4-(di-p-tolylamino)-4′-[4(di-p-tolylamino)-styryl]stilbene

N,N,N′,N′-Tetra-p-tolyl-4-4′-diaminobiphenyl

N,N,N′,N′-Tetraphenyl-4,4′-diaminobiphenyl

N,N,N′,N′-tetra-1-naphthyl-4,4′-diaminobiphenyl

N,N,N′,N′-tetra-2-naphthyl-4,4′-diaminobiphenyl

N-Phenylcarbazole

4,4′-Bis[N-(1-naphthyl)-N-phenylamino]biphenyl

4,4′-Bis[N-(1-naphthyl)-N-(2-naphthyl)amino]biphenyl

4,4″-Bis[N-(1-naphthyl)-N-phenylamino]p-terphenyl

4,4′-Bis[N-(2-naphthyl)-N-phenylamino]biphenyl

4,4′-Bis[N-(3-acenaphthenyl)-N-phenylamino]biphenyl

1,5-Bis[N-(1-naphthyl)-N-phenylamino]naphthalene

4,4′-Bis[N-(9-anthryl)-N-phenylamino]biphenyl

4,4″-Bis[N-(1-anthryl)-N-phenylamino]-p-terphenyl

4,4′-Bis[N-(2-phenanthryl)-N-phenylamino]biphenyl

4,4′-Bis[N-(8-fluoranthenyl)-N-phenylamino]biphenyl

4,4′-Bis[N-(2-pyrenyl)-N-phenylamino]biphenyl

4,4′-Bis[N-(2-naphthacenyl)-N-phenylamino]biphenyl

4,4′-Bis[N-(2-perylenyl)-N-phenylamino]biphenyl

4,4′-Bis[N-(1-coronenyl)-N-phenylamino]biphenyl

2,6-Bis(di-p-tolylamino)naphthalene

2,6-Bis[di-(1-naphthyl)amino]naphthalene

2,6-Bis[N-(1-naphthyl)-N-(2-naphthyl)amino]naphthalene

N,N,N′,N′-Tetra(2-naphthyl)-4,4″-diamino-p-terphenyl

4,4′-Bis{N-phenyl-N-[4-(1-naphthyl)-phenyl]amino}biphenyl

4,4′-Bis[N-phenyl-N-(2-pyrenyl)amino]biphenyl

2,6-Bis[N,N-di(2-naphthyl)amine]fluorene

1,5-Bis[N-(1-naphthyl)-N-phenylamino]naphthalene

4,4′,4″-tris[(3-methylphenyl)phenylamino]triphenylamine

Another class of useful hole-transporting materials includes polycyclic aromatic compounds as described in EP 1 009 041. Tertiary aromatic amines with more than two amine groups may be used including oligomeric materials. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

Light-Emitting Layer (LEL)

As more fully described in U.S. Pat. Nos. 4,769,292 and 5,935,721, the light-emitting layer (LEL) 109 of the organic EL element includes a luminescent or fluorescent material where electroluminescence is produced as a result of electron-hole pair recombination in this region. The light-emitting layer can be comprised of a single material, but more commonly consists of a host material doped with a guest compound or compounds where light emission comes primarily from the dopant and can be of any color. The host materials in the light-emitting layer can be an electron-transporting material, as defined below, a hole-transporting material, as defined above, or another material or combination of materials that support hole-electron recombination. The dopant is usually chosen from highly fluorescent dyes, but phosphorescent compounds, e.g., transition metal complexes as described in WO 98/55561, WO 00/18851, WO 00/57676, and WO 00/70655 are also useful. Dopants are typically coated as 0.01 to 10 % by weight into the host material. Polymeric materials such as polyfluorenes and polyvinylarylenes (e.g., poly(p-phenylenevinylene), PPV) can also be used as the host material. In this case, small molecule dopants can be molecularly dispersed into the polymeric host, or the dopant could be added by copolymerizing a minor constituent into the host polymer.

An important relationship for choosing a dye as a dopant is a comparison of the bandgap potential which is defined as the energy difference between the highest occupied molecular orbital and the lowest unoccupied molecular orbital of the molecule. For efficient energy transfer from the host to the dopant molecule, a necessary condition is that the band gap of the dopant is smaller than that of the host material. For phosphorescent emitters it is also important that the host triplet energy level of the host be high enough to enable energy transfer from host to dopant.

Host and emitting molecules known to be of use include, but are not limited to, those disclosed in U.S. Pat. Nos. 4,769,292; 5,141,671; 5,150,006; 5,151,629; 5,405,709; 5,484,922; 5,593,788; 5,645,948; 5,683,823; 5,755,999; 5,928,802; 5,935,720; 5,935,721; and 6,020,078.

Metal complexes of 8-hydroxyquinoline (oxine) and similar derivatives constitute one class of useful host compounds capable of supporting electroluminescence. Illustrative of useful chelated oxinoid compounds are the following:

CO-1: Aluminum trisoxine [alias, tris(8-quinolinolato)aluminum(III)]

CO-2: Magnesium bisoxine [alias, bis(8-quinolinolato)magnesium(II)]

CO-3: Bis[benzo{f}-8-quinolinolato]zinc (II)

CO-4: Bis(2-methyl-8-quinolinolato)aluminum(III)-□-oxo-bis(2-methyl-8-quinolinolato) aluminum(III)

CO-5: Indium trisoxine [alias, tris(8-quinolinolato)indium]

CO-6: Aluminum tris(5-methyloxine) [alias, tris(5-methyl-8-quinolinolato) aluminum(III)]

CO-7: Lithium oxine [alias, (8-quinolinolato)lithium(I)]

CO-8: Gallium oxine [alias, tris(8-quinolinolato)gallium(III)]

CO-9: Zirconium oxine [alias, tetra(8-quinolinolato)zirconium(IV)]

Other classes of useful host materials include, but are not limited to: derivatives of anthracene, such as 9,10-di-(2-naphthyl)anthracene and derivatives thereof as described in U.S. Pat. No. 5,935,721, distyrylarylene derivatives as described in U.S. Pat. No. 5,121,029, and benzazole derivatives, for example, 2,2′,2″-(1,3,5-phenylene)tris[1-phenyl-1H-benzimidazole]. Carbazole derivatives are particularly useful hosts for phosphorescent emitters.

Useful fluorescent dopants include, but are not limited to, derivatives of anthracene, tetracene, xanthene, perylene, rubrene, coumarin, rhodamine, and quinacridone, dicyanomethylenepyran compounds, thiopyran compounds, polymethine compounds, pyrilium and thiapyrilium compounds, fluorene derivatives, periflanthene derivatives, indenoperylene derivatives, bis(azinyl)amine boron compounds, bis(azinyl)methane compounds, and carbostyryl compounds.

Electron-Transporting Layer (ETL)

Preferred thin-film-forming materials for use in forming the electron-transporting layer 111 of the organic EL elements of this invention are metal chelated oxinoid compounds, including chelates of oxine itself (also commonly referred to as 8-quinolinol or 8-hydroxyquinoline). Such compounds help to inject and transport electrons, exhibit high levels of performance, and are readily fabricated in the form of thin-films. Exemplary oxinoid compounds were listed previously.

Other electron-transporting materials include various butadiene derivatives as disclosed in U.S. Pat. No. 4,356,429 and various heterocyclic optical brighteners as described in U.S. Pat. No. 4,539,507. Benzazoles and triazines are also useful electron-transporting materials.

Cathode

When light emission is viewed solely through the anode, the cathode 113 used in this invention can be comprised of nearly any conductive material. Desirable materials have good film-forming properties to ensure good contact with the underlying organic layer, promote electron injection at low voltage, and have good stability. Useful cathode materials often contain a low work function metal (<4.0 eV) or metal alloy. One preferred cathode material is comprised of a Mg:Ag alloy wherein the percentage of silver is in the range of 1 to 20%, as described in U.S. Pat. No. 4,885,221. Another suitable class of cathode materials includes bilayers comprising a thin electron-injection layer (EIL) in contact with the organic layer (e.g., ETL) which is capped with a thicker layer of a conductive metal. Here, the EIL preferably includes a low work function metal or metal salt, and if so, the thicker capping layer does not need to have a low work function. One such cathode is comprised of a thin layer of LiF followed by a thicker layer of Al as described in U.S. Pat. No. 5,677,572. Other useful cathode material sets include, but are not limited to, those disclosed in U.S. Pat. Nos. 5,059,861; 5,059,862, and 6,140,763.

When light emission is viewed through the cathode, the cathode must be transparent or nearly transparent. For such applications, metals must be thin or one must use transparent conductive oxides, or a combination of these materials. Optically transparent cathodes have been described in more detail in U.S. Pat. No. 4,885,211, U.S. Pat. No. 5,247,190, JP 3,234,963, U.S. Pat. No. 5,703,436, U.S. Pat. No. 5,608,287, U.S. Pat. No. 5,837,391, U.S. Pat. No. 5,677,572, U.S. Pat. No. 5,776,622, U.S. Pat. No. 5,776,623, U.S. Pat. No. 5,714,838, U.S. Pat. No. 5,969,474, U.S. Pat. No. 5,739,545, U.S. Pat. No. 5,981,306, U.S. Pat. No. 6,137,223, U.S. Pat. No. 6,140,763, U.S. Pat. No. 6,172,459, EP 1 076 368, U.S. Pat. No. 6,278,236, and U.S. Pat. No. 6,284,393. Cathode materials are typically deposited by evaporation, sputtering, or chemical vapor deposition. When needed, patterning can be achieved through many well known methods including, but not limited to, through-mask deposition, integral shadow masking, for example, as described in U.S. Pat. No. 5,276,380 and EP 0 732 868, laser ablation, and selective chemical vapor deposition.

Other Common Organic Layers and Device Architecture

In some instances, layers 109 and 111 can optionally be collapsed into a single layer that serves the function of supporting both light emission and electron transportation. It also known in the art that emitting dopants may be added to the hole-transporting layer, which may serve as a host. Multiple dopants may be added to one or more layers in order to create a white-emitting OLED, for example, by combining blue- and yellow-emitting materials, cyan- and red-emitting materials, or red-, green-, and blue-emitting materials. White-emitting devices are described, for example, in EP 1 187 235, U.S. Pat. No. 20020025419, EP 1 182 244, U.S. Pat. No. 5,683,823, U.S. Pat. No. 5,503,910, U.S. Pat. No. 5,405,709, and U.S. Pat. No. 5,283,182.

Additional layers such as electron or hole-blocking layers as taught in the art may be employed in devices of this invention. Hole-blocking layers are commonly used to improve efficiency of phosphorescent emitter devices, for example, as in U.S. 20020015859.

This invention may be used in so-called stacked device architecture, for example, as taught in U.S. Pat. No. 5,703,436 and U.S. Pat. No. 6,337,492.

Deposition of organic layers

The organic materials mentioned above are suitably deposited through a vapor-phase method such as sublimation, but can be deposited from a fluid, for example, from a solvent with an optional binder to improve film formation. If the material is a polymer, solvent deposition is useful but other methods can be used, such as sputtering or thermal transfer from a donor sheet. The material to be deposited by sublimation can be vaporized from a sublimator “boat” often comprised of a tantalum material, e.g., as described in U.S. Pat. No. 6,237,529, or can be first coated onto a donor sheet and then sublimed in closer proximity to the substrate. Layers with a mixture of materials can utilize separate sublimator boats or the materials can be pre-mixed and coated from a single boat or donor sheet. Patterned deposition can be achieved using shadow masks, integral shadow masks (U.S. Pat. No. 5,294,870), spatially-defined thermal dye transfer from a donor sheet (U.S. Pat. Nos. 5,688,551, 5,851,709 and 6,066,357) and inkjet method (U.S. Pat. No. 6,066,357).

Encapsulation

Most OLED devices are sensitive to moisture or oxygen, or both, so they are commonly sealed in an inert atmosphere such as nitrogen or argon, along with a desiccant such as alumina, bauxite, calcium sulfate, clays, silica gel, zeolites, alkaline metal oxides, alkaline earth metal oxides, sulfates, or metal halides and perchlorates. Methods for encapsulation and desiccation include, but are not limited to, those described in U.S. Pat. No. 6,226,890. In addition, barrier layers such as SiOx, Teflon, and alternating inorganic/polymeric layers are known in the art for encapsulation.

Optical Optimization

OLED devices of this invention can employ various well-known optical effects in order to enhance its properties if desired. This includes optimizing layer thicknesses to yield maximum light transmission, providing dielectric mirror structures, replacing reflective electrodes with light-absorbing electrodes, providing anti glare or anti-reflection coatings over the display, providing a polarizing medium over the display, or providing colored, neutral density, or color conversion filters over the display. Filters, polarizers, and anti-glare or anti-reflection coatings may be specifically provided over the cover or as part of the cover.

The entire contents of the patents and other publications referred to in this specification are incorporated herein by reference.

The invention has been described in detail with particular reference to certain preferred embodiments thereof, but it will be understood that variations and modifications can be effected within the spirit and scope of the invention.

PARTS LIST

| | |
|---|---|
| 10 | user |
| 11 | light emitting pointer |
| 12 | substrate |
| 13 | point of light |
| 14 | tiled interactive display |
| 15 | display tiles |
| 16 | controller |
| 17 | faceplates |
| 18 | computer |
| 19 | viewable surface |
| 21 | light pipe |
| 22 | light emitting pixels |
| 24 | photosensors |
| 26 | standard communication interface |
| 30 | digital signal processor |
| 32 | memory |
| 34 | temporal filter |
| 36 | spatial filter |
| 103 | anode |
| 105 | hole injection layer |
| 107 | hole transport layer |
| 109 | light emitting layer |
| 111 | electron transport layer |
| 113 | cathode |
| 250 | voltage/current source |
| 260 | electrical conductors |

What is claimed is:

1. An OLED display, comprising:
a) a two dimensional array of light emitting pixels for displaying an image;
b) a two dimensional array of photosensors interspersed with the array of light emitting pixels for producing an incident light signal; and
c) a display controller connected to the array of photosensors, the display controller including a signal processor responsive to the incident light signal for detecting the location of a point of light directed onto the display by a light emitting pointer and generating a pointer signal representing the location of the point of light.

2. The display claimed in claim 1, wherein the light emitting pointer is a laser.

3. The display claimed in claim 1, wherein the light emitted from the pointer is modulated in time.

4. The display claimed in claim 1, wherein the signal processor is capable of simultaneously detecting a plurality of points of light emitted by a plurality of light emitting pointers.

5. The display claimed in claim 4, wherein the light emitting pointers emit light modulated in time, and each pointer modulates the light at a different frequency, and the signal processor is capable of detecting which light emitting pointer emitted light emitted from the plurality of light emitting pointers are distinguished by having different frequencies of modulation.

6. The display claimed in claim 1, wherein a photosensor is associated with each light emitting pixel.

7. The display claimed in claim 1, wherein the display is a tiled display.

8. The display claimed in claim 7, wherein each tile includes an image expanding optical face plate.

9. The display claimed in claim 1, wherein the signal processor includes a temporal filter responsive to the incident light signal to produce a difference signal and a spatial filter responsive to the difference signal to generate the pointer signal.

10. A method of interacting with a display, comprising the steps of:
a) providing an OLED display having,
i) a two dimensional array of light emitting pixels for displaying an image;
ii) a two dimensional array of photosensors interspersed with the array of light emitting pixels; and
iii) a display controller connected to the array of photosensors, the display controller including a signal processor for detecting the location of a point of light directed onto the display by a light emitting pointer and generating a signal representing the location of the point of light;
b) illuminating the display with a point of light from the light emitting pointer;
c) detecting the location of the point of light; and
d) selectively changing the image being displayed by the display in response to the location of the point of light.

11. The method claimed in claim 10, wherein the interaction includes manipulation of objects in a graphical user interface.
